(19) United States
(12) Patent Application Publication
(10) Pub. No.: US 2026/0137240 A1
(43) Pub. Date: May 21, 2026

(54) MIXING BOWL

(71) Applicant: Comasia Ana Reeves, Bartlesville, OK (US)

(72) Inventor: Comasia Ana Reeves, Bartlesville, OK (US)

(21) Appl. No.: 18/953,299

(22) Filed: Nov. 20, 2024

(51) Int. Cl. A47J 43/07

(52) U.S. Cl. CPC A47J 43/0727

(57) ABSTRACT

A mixing bowl for facilitating mixing and pouring food components includes a lower shell and an upper shell which comprise resiliently flexible materials and a core band fixed between the lower and upper shells which comprises a rigid material. The core band helps the mixing bowl maintain its shape and may be gripped while mixing components. To pour components, spouts may be formed at opposite ends of the core band by pressing portions of the lower shell and the upper shell inwardly over the core band. Pressing these portions inwardly directs food that would otherwise spill to be poured over one of the spouts when the mixing bowl is tilted.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to mixing bowls and more particularly pertains to a new mixing bowl for facilitating mixing and pouring food components.

(2) Description of Related Art Including Information Disclosed Under 37 CFR 1.97 and 1.98.

Mixing bowls of the prior art primarily allow for accurate pouring of items out of the mixing bowls via spouts that are permanently formed into the walls of the mixing bowls. However, this may present a problem, especially when attempting to pour ingredients that do not flow well from relatively thin spouts. Mixing bowls are typically made with wider mouths to accommodate significant mixing motions over wide regions of the mixing bowls, and spouts may not be able to direct all of a mixture precisely when they only cover a small section of the mixing bowls.

The prior art discloses mixing bowls which facilitate pouring through handles, frictional materials, and the like. However, the prior art fails to describe such a mixing bowl which comprises flexible and rigid components such that the mixing bowl may have a wide, rounded shape when mixing ingredients and may be shaped via bending of the flexible components to direct the ingredients to align with a spout formed in the mixing bowl by the bending action.

### (H) BRIEF SUMMARY OF THE INVENTION

An embodiment of the disclosure meets the needs presented above by generally comprising a lower shell has a bottom wall and a perimeter wall, wherein the perimeter wall is coupled to and extends upwardly from the bottom wall. The lower shell defines a cavity which is surrounded by the bottom wall and the perimeter wall. The perimeter wall has a top edge opposite the bottom wall. An upper shell is nested in the cavity of the lower shell. The upper shell has a base wall and a peripheral wall, wherein the peripheral wall is coupled to and extends upwardly from the base wall. The upper shell defines an interior space which is surrounded by the base wall and the peripheral wall. The peripheral wall has an upper rim opposite the base wall. A core band is positioned between the lower shell and the upper shell. The core band extends from a front portion of the top edge of the perimeter wall of the lower shell to a rear portion of the top edge of the perimeter wall of the lower shell.

The lower shell comprises a resiliently deformable material, the upper shell comprises a resiliently flexible material, and the core band comprises a rigid material. Lateral portions of the lower shell and the upper shell are bendable inwardly from a resting state, and the core band reinforces the lower shell and the upper shell such that the lower shell and the upper shell substantially retain their shapes along a length of the core band when the lateral portions are bent.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a mixing bowl according to an embodiment of the disclosure.

FIG. 2 is a top view of an embodiment of the disclosure.

FIG. 3 is a front view of an embodiment of the disclosure.

FIG. 4 is a cross-sectional view of an embodiment of the disclosure taken from Line 4-4 in FIG. 3.

FIG. 5 is a detail view of an embodiment of the disclosure taken from Window 5 in FIG. 4.

FIG. 6 is a top view of an embodiment of the disclosure in which lateral portions of a lower shell and an upper shell are bent inwardly from a resting state.

### (J) DETAILED DESCRIPTION OF THE INVENTION

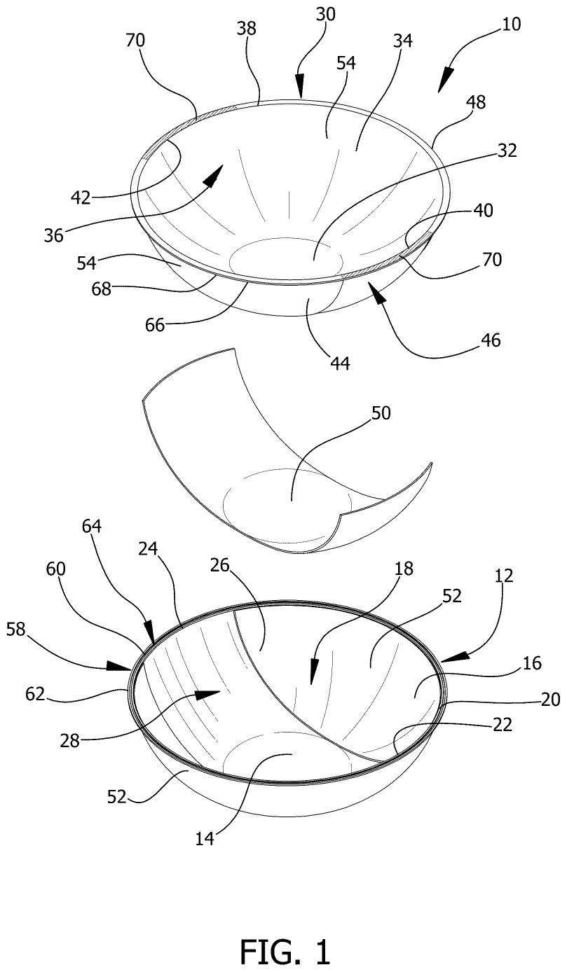

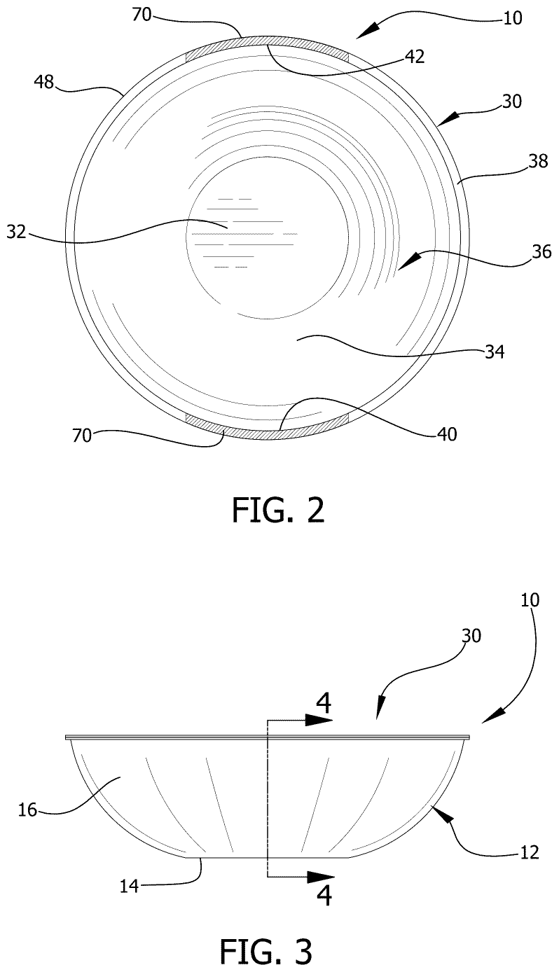

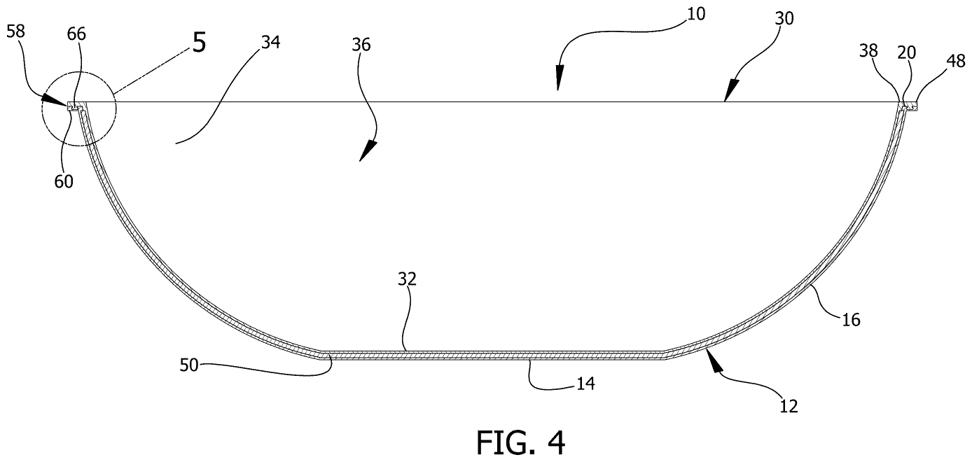

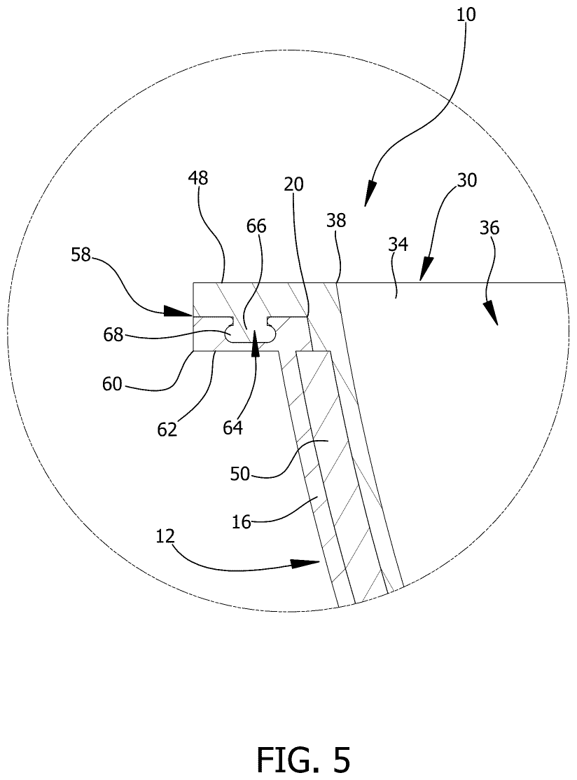

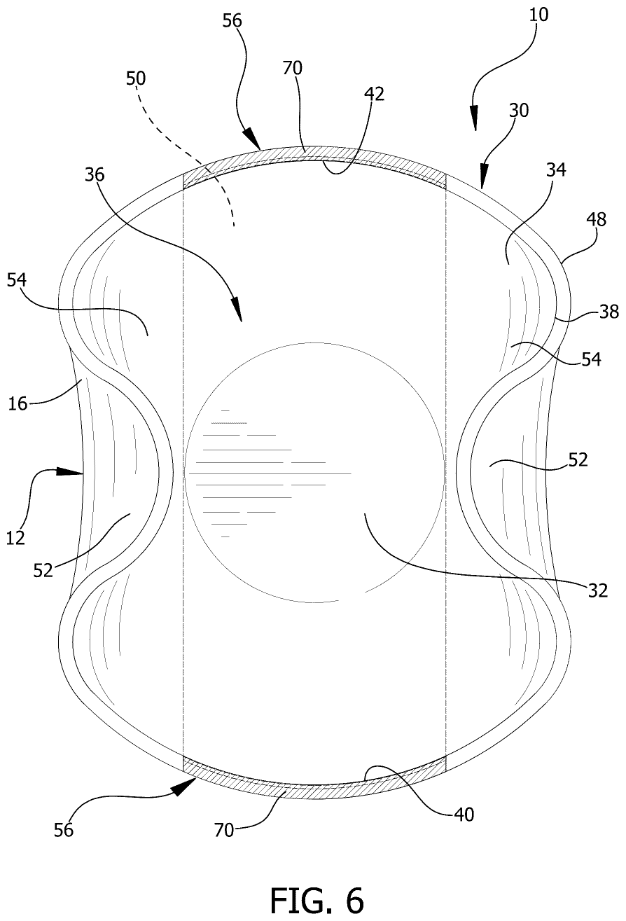

With reference now to the drawings, and in particular to FIGS. 1 through 6 thereof, a new mixing bowl embodying the principles and concepts of an embodiment of the disclosure and generally designated by the reference numeral 10 will be described.

As best illustrated in FIGS. 1 through 6, the mixing bowl 10 generally comprises a lower shell 12 which has a bottom wall 14 and a perimeter wall 16. The perimeter wall 16 is coupled to and extends upwardly from the bottom wall 14. The lower shell 12 defines a cavity 18 which is surrounded by the bottom wall 14 and the perimeter wall 16. The bottom wall 14 has a planar shape, and the perimeter wall 16 has a dome shape. The perimeter wall 16 has a top edge 20 opposite the bottom wall 14. The lower shell 12 defines an inner recess 28 in an interior surface 26 of the lower shell 12 which extends from a front portion 22 of the top edge 20 to a rear portion 24 of the top edge 20.

An upper shell 30 is nested in the cavity 18 of the lower shell 12. The upper shell 30 has a base wall 32 and a peripheral wall 34, wherein the peripheral wall 34 is coupled to and extends upwardly from the base wall 32. The upper shell 30 defines an interior space 36 which is surrounded by the base wall 32 and the peripheral wall 34. The base wall 32 has a planar shape, and the peripheral wall 34 has a dome shape. The peripheral wall 34 has an upper rim 38 opposite the base wall 32. The upper shell 30 defines an outer recess 46 in an exterior surface 44 of the upper shell 30 which extends from a front section 40 of the upper rim 38 to a rear section 42 of the upper rim 38. The upper shell 30 further comprises a lip 48 which is coupled to and protrudes outwardly from the upper rim 38 of the peripheral wall 34.

A core band 50 is positioned between the lower shell 12 and the upper shell 30. The core band 50 seats in the inner recess 28 of the lower shell 12 and the outer recess 46 of the upper shell 30 and is coextensive with the inner recess 28 of the lower shell 12 and the outer recess 46 of the upper shell 30.

The lower shell 12 comprises a resiliently deformable material, the upper shell 30 comprises a resiliently flexible material, and the core band 50 comprises a rigid material. Lateral portions 52, 54 of the lower shell 12 and the upper shell 30 are bendable inwardly from a resting state, and the core band 50 reinforces the lower shell 12 and the upper shell 30 such that the lower shell 12 and the upper shell 30 retain their shapes along a length of the core band 50. Thus, as a result of bending the lateral portions 52, 54 of the lower shell 12 and the upper shell 30 inwardly, the mixing bowl 10 is shaped to form spouts 56 on opposite ends of the core band 50. When the lateral portions 52, 54 are released, the lower shell 12 and the upper shell 30 resiliently return to the resting state from which they began. The resiliently deformable material and the resiliently flexible material may be the same material and may be rubber, silicone, another resilient plastic, or the like. The rigid material may be a metal, a rigid plastic, a ceramic, a wood, or the like.

A connector 58 releasably couples to the lower shell 12 and the upper shell 30. The connector 58 comprises a lower mating member 60 and an upper mating member 66. The lower mating member 60 is coupled to the lower shell 12 and comprises a receiver 62 which extends around the top edge 20 of the perimeter wall 16 of the lower shell 12. The receiver 62 defines a groove 64 which extends around the top edge 20. The upper mating member 66 is coupled to the upper shell 30 and comprises a rail 68 which is coupled to the lip 48 and extends around the upper rim 38 of the peripheral wall 34 of the upper shell 30. The rail 68 has a snap fit with the groove 64 of the receiver 62.

The core band 50 is fixed with respect to the lower shell 12 and the upper shell 30 when seated in the inner recess 28 of the lower shell 12 and the outer recess 46 of the upper shell 30. The lower mating member 60 is integrally formed with the lower shell 12, and the upper mating member 66 is integrally formed with the upper shell 30. The connector 58 may comprise other suitable fasteners such as a magnetic fastener, a hook-and-loop fastener, a latch, a clamp, or the like. In some embodiments, the lower shell 12, the upper shell 30, and the core band 50 may be permanently fixed or fastened with respect to each other. In some embodiments, the lower shell 12 and the upper shell 30 may be integrally formed with each other.

An indicia 70 is coupled to the upper shell 30 and is positioned on the front portion 22 and the rear portion 24 of the upper rim 38 and on the lip 48 adjacent to the front portion 22 and the rear portion 24 of the upper rim 38. The indicia 70 indicates a location of the core band 50 such that a user may identify the locations at which the spouts 56 may be formed by bending the lateral portions 52, 54 of the lower shell 12 and the upper shell 30 inwardly. The Figures shows the indicia 70 as a brown color, but the indicia 70 may be any color that is distinct from the color of surrounding portions of one or both of the lower shell 12 and the upper shell 30. In other embodiments, the indicia 70 may include other printed markings, embossed features, indentations, or the like. The indicia 70 may include symbols, alphanumeric characters, graphical images, or the like.

In use, the mixing bowl 10 may be used as conventional to hold items such as food components, and such food components or other items may be mixed together. The mixing bowl 10 may be grasped where the core band 50 is located to secure the mixing bowl 10 without deforming the shape of the mixing bowl 10. To pour the items held in the mixing bowl 10, the lateral portions 52, 54 of the lower shell 12 and the upper shell 30 may be bent inwardly to form the spouts 56, then the items may be poured via one or both of the spouts 56. By forming and pouring via the spouts 56, chances of spills are decreased by decreasing the width of the portion of the upper rim 38 of the upper shell 30 over which the items are poured. The lateral portions 52, 54 may also direct the items to be poured over one of the spouts 56 when the mixing bowl 10 is tilted.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mixing bowl comprising:
a lower shell having a bottom wall and a perimeter wall, the perimeter wall being coupled to and extending upwardly from the bottom wall, the lower shell defining a cavity surrounded by the bottom wall and the perimeter wall, the perimeter wall having a top edge opposite the bottom wall, the lower shell comprising a resiliently deformable material;
an upper shell nested in the cavity of the lower shell, the upper shell having a base wall and a peripheral wall, the peripheral wall being coupled to and extending upwardly from the base wall, the upper shell defining an interior space surrounded by the base wall and the peripheral wall, the peripheral wall having an upper rim opposite the base wall, the upper shell comprising a resiliently flexible material;
a core band being positioned between the lower shell and the upper shell, the core band comprising a rigid material, the core band extending from a front portion of the top edge of the perimeter wall of the lower shell to a rear portion of the top edge of the perimeter wall of the lower shell; and
wherein lateral portions of the lower shell and the upper shell are bendable inwardly, the core band reinforcing the lower shell and the upper shell such that the lower shell and the upper shell substantially retain their shapes along a length of the core band.

2. The mixing bowl of claim 1, wherein:
the bottom wall of the lower shell has a planar shape, the perimeter wall of the lower shell having a dome shape; and
the base wall of the upper shell a planar shape, the peripheral wall of the upper shell having a dome shape.

3. The mixing bowl of claim 1, wherein:
the lower shell defining an inner recess in an interior surface of the lower shell, the inner recess extending from the front portion of the top edge to the rear portion of the top edge; and
the core band seats in the inner recess of the lower shell, the core band being coextensive with the inner recess.

4. The mixing bowl of claim 1, wherein:
the upper shell defining an outer recess in an exterior surface of the upper shell, the outer recess extending from a front section of the upper rim to a rear section of the upper rim; and
the core band seating in the outer recess of the upper shell, the core band being coextensive with the outer recess of the upper shell.

5. The mixing bowl of claim 1, further comprising a connector releasably coupling the lower shell and the upper shell.

6. The mixing bowl of claim 5, wherein the connector comprises a lower mating member and an upper mating member, the lower mating member being coupled to and extending around the top edge of the perimeter wall of the lower shell, the upper mating member being coupled to and extending around the upper rim of the peripheral wall of the upper shell.

7. The mixing bowl of claim 6, wherein:
the upper shell further comprising a lip which is coupled to and protrudes outwardly from the upper rim of the peripheral wall;
the lower mating member of the connector comprises a receiver, the receiver defining a groove which extends around the top edge of the perimeter wall of the lower shell; and
the upper mating member of the connector comprises a rail coupled to the lip and extending around the upper rim of the peripheral wall of the upper shell, the rail having a snap fit with the groove of the receiver.

8. The mixing bowl of claim 7, wherein:
the lower mating member is integrally formed with the lower shell; and
the upper mating member is integrally formed with the upper shell.

9. The mixing bowl of claim 1, further comprising:
an indicia coupled to the upper shell, the indicia being positioned on the front portion and the rear portion of the upper rim the indicia indicating a location of the core band.

10. A mixing bowl comprising:
a lower shell having a bottom wall and a perimeter wall, the perimeter wall being coupled to and extending upwardly from the bottom wall, the lower shell defining a cavity surrounded by the bottom wall and the perimeter wall, the bottom wall having a planar shape, the perimeter wall having a dome shape, the perimeter wall having a top edge opposite the bottom wall, the lower shell defining an inner recess in an interior surface of the lower shell, the inner recess extending from a front portion of the top edge to a rear portion of the top edge, the lower shell comprising a resiliently deformable material;
an upper shell nested in the cavity of the lower shell, the upper shell having a base wall and a peripheral wall, the peripheral wall being coupled to and extending upwardly from the base wall, the upper shell defining an interior space surrounded by the base wall and the peripheral wall, the base wall having a planar shape, the peripheral wall having a dome shape, the peripheral wall having an upper rim opposite the base wall, the upper shell defining an outer recess in an exterior surface of the upper shell, the outer recess extending from a front section of the upper rim to a rear section of the upper rim, the upper shell comprising a resiliently flexible material, the upper shell further comprising a lip which is coupled to and protrudes outwardly from the upper rim of the peripheral wall;
a core band being positioned between the lower shell and the upper shell, the core band seating in the inner recess of the lower shell and the outer recess of the upper shell, the core band being coextensive with the inner recess of the lower shell and the outer recess of the upper shell, the core band comprising a rigid material;
wherein lateral portions of the lower shell and the upper shell are bendable inwardly, the core band reinforcing the lower shell and the upper shell such that the lower shell and the upper shell substantially retain their shapes along a length of the core band;
a connector releasably coupling the lower shell and the upper shell, the connector comprising:
a lower mating member coupled to the lower shell, the lower mating member comprising a receiver which extends around the top edge of the perimeter wall of the lower shell, the receiver defining a groove which extends around the top edge, the lower mating member being integrally formed with the lower shell; and
an upper mating member coupled to the upper shell, the upper mating member comprising a rail which is coupled to the lip and extends around the upper rim of the peripheral wall of the upper shell, the rail having a snap fit with the groove of the receiver, the upper mating member being integrally formed with the upper shell; and
an indicia coupled to the upper shell, the indicia being positioned on the front portion and the rear portion of the upper rim and on the lip adjacent to the front portion and the rear portion of the upper rim, the indicia indicating a location of the core band.
